(19) United States
(12) Patent Application Publication
(10) Pub. No.: US 2002/0138990 A1
(43) Pub. Date: Oct. 3, 2002

(54) Metal cutting shears

(75) Inventors: Steven J. Gluck, Wausau, WI (US); Lloyd W. Brandenburg JR., Wausau, WI (US)

Correspondence Address: David J. Bates, FOLEY & LARDNER, Firstar Center, 777 East Wisconsin Avenue, Milwaukee, WI, 53202-5367, US

(73) Assignee: Alterra Holdings Corporation

(21) Appl. No.: 09/822,991

(22) Filed: Mar. 30, 2001

(51) Int. Cl. B26B 13/00

(52) U.S. Cl. 30/258; 30/254

(57) ABSTRACT

A shears for cutting sheet metal or similar material located in a raised position, such as above the shoulders of the operator, includes front and rear handle members and upper and lower blade members. The handle members are pivotally connected together at a handle pivot point adjacent the upper ends of the handle members. The blade members are pivotally connected together at a blade pivot point located above the pivoted upper ends of the handle members. In addition, the shanks of the upper and lower blade members are pivotally connected to the front and rear handle members at respective front and rear pivot points located along the lengths of the handle members. Each blade member includes a cutting edge that extends perpendicularly or obliquely relative to the longitudinal direction of the handle member to which the blade member is pivotally connected. The handle members may be provided with soft cushion-like hand-grips to improve the operator's comfort and grip.

### FIELD OF THE INVENTION

The present invention relates to shears for cutting sheet metal or similar material. More specifically, the invention relates to a hand operated metal cutting shears in which the cutting/operating plane is offset from the actuating plane.

### BACKGROUND OF THE INVENTION

Hand operated shears designed for cutting sheet metal or similar material are widely used. The importance and wide use of such sheet metal shears, commonly known as aviation shears, has lead to the development of very specialized designs. For instance, U.S. Pat. Nos. 3,839,794, 4,967,475 and 4,463,497 disclose sheet metal shears primarily designed to cut irregular designs or holes. These aviation shears are also adapted for trimming close to wall surfaces and other such areas.

While there have been many improvements in aviation shears, present designs are still not satisfactory for cutting sheet metal or similar material when the material is in certain locations, for example, above the operator's shoulders. With most present designs of cutting shears, the operator's arms must be held in a raised and/or outstretched position during the cutting operation to maintain the cutting plane of the shears in alignment with the plane of the material being cut. When the operator's arms are in this raised and/or outstretched position, it can be difficult for the operator to generate sufficient power for cutting the material. The difficulty of this cutting operation can be further increased if the edges of the cut sheet material interfere with the body or handles of the shears, as often happens with present aviation shears designs. This interference not only makes it difficult for the operator to perform the cutting operation but can also distort the cut edges.

### SUMMARY OF THE INVENTION

The present invention facilitates the cutting of sheet metal or similar material when the material is located in a raised or lowered position, such as above the shoulders of the operator or below the operator's waist. This is accomplished by providing an aviation shears with a powerful compound cutting action in which the cutting/operating plane is offset from the actuating plane.

According to one aspect of the invention, a shears for cutting a sheet material includes first and second handle members and first and second blade members. The handle members are pivotally connected together at a first pivot point adjacent one of the ends of the handle members. The blade members are pivotally connected together at a second pivot point located beyond the pivoted ends of the handle members. The first and second blade members are also pivotally connected to the respective first and second handle members at respective third and fourth pivot points located along the length of each handle member. Each blade member includes a cutting edge that extends at an angle relative to a longitudinal direction of the handle member to which the blade member is pivotally connected.

According to another aspect of this invention, a shears for cutting a sheet material includes first and second handle members and first and second blade members. The handle members are pivotally connected together at a first pivot point, and the blade members are pivotally connected together at a second pivot point. The first and second blade members are also pivotally connected to the first and second handle members at respective third and fourth pivot points. Each blade member includes a cutting edge that extends substantially perpendicular relative to a longitudinal direction of the handle member to which the blade member is pivotally connected.

According to further aspect of this invention, a shears for cutting a sheet material located above the shoulders of an operator includes front and rear handle members and upper and lower blade members. The handle members are pivotally connected together at a first pivot point adjacent an upper end of each handle member. The blade members are pivotally connected together at a second pivot point located above the upper ends of the handle members. In addition, the upper and lower-blade members are pivotally connected to the front and rear handle members at respective third and fourth pivot points located along the length of each handle member. Each blade member includes a cutting edge that extends obliquely relative to a longitudinal direction of the handle member to which the blade member is pivotally connected. Alternatively, each cutting edge may be arranged to extend substantially perpendicularly relative to the longitudinal direction of the handle member to which the blade member is pivotally connected.

According to yet another aspect of this invention, a shears for cutting a sheet material comprises a pair of elongated handles and a pair of blades. The pair of handles are pivotally connected adjacent one of the ends thereof. The pair of blades are pivotable between an open position and a closed position by actuation of the handles. The blades include cooperating cutting edges that extend substantially perpendicular to a line extending between the handles when the blades are in the closed position.

These and other benefits and features of the invention will be apparent upon consideration of the following detailed description of preferred embodiments thereof, presented in connection with the following drawings in which like reference numerals identify like elements throughout.

### BRIEF DESCRIPTION OF THE DRAWINGS

FIG. 1 is left side elevation view of a shears in accordance with one aspect of the present invention, the shears being shown in the closed position.

FIG. 2 is a left side elevation view of the shears of FIG. 1, the shears being shown in the open position.

FIG. 3 is a front view of the upper end of the shears of FIG. 1, the shears being shown in the closed position.

FIG. 4 is a front view of the upper end of the shears of FIG. 2, the shears being shown in the open position.

FIG. 5 is left side elevation view of a shears in accordance with another aspect of the present invention, the shears being shown in the closed position.

FIG. 6 is a left side elevation view of the shears of FIG. 5, the shears being shown in the open position.

FIG. 7 is a front view of the upper end of the shears of FIG. 5, the shears being shown in the closed position.

FIG. 8 is a front view of the upper end of the shears of FIG. 6, the shears being shown in the open position.

### DETAILED DESCRIPTION OF THE PREFERRED EMBODIMENTS

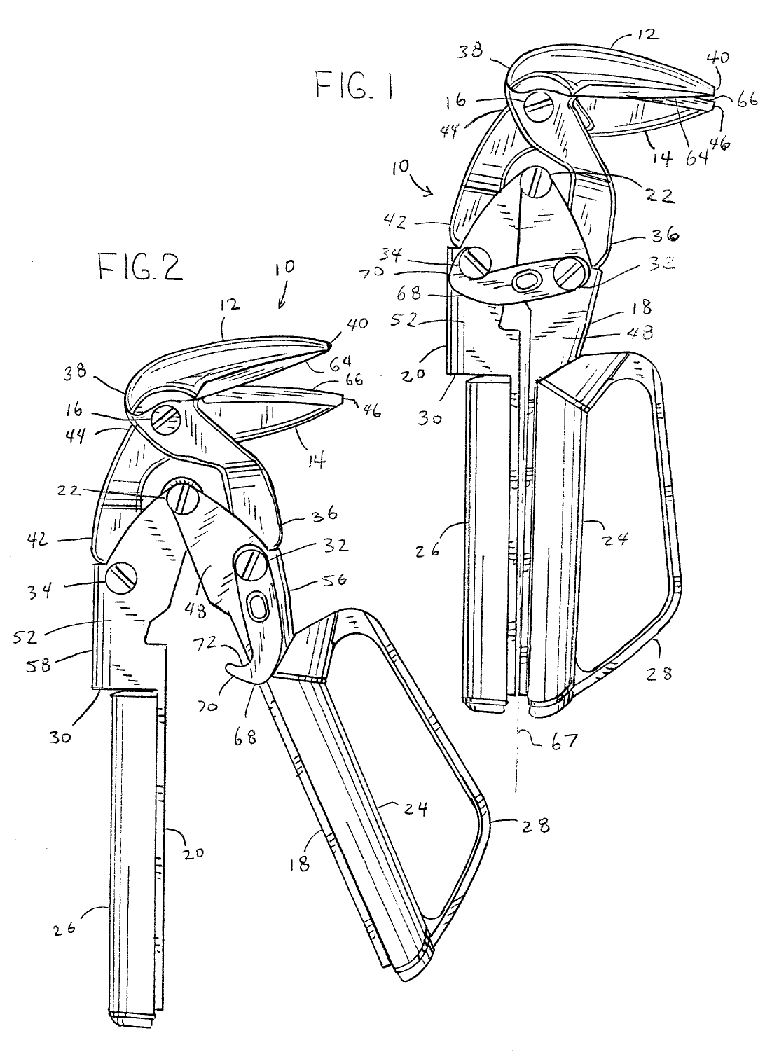

Referring to FIGS. 1 and 2, a preferred embodiment of a shears 10 in accordance with the present invention is shown. As oriented in the FIGURES, shears 10 facilitates the cutting of a sheet material located in a raised position, for example, above the shoulders of an operator. Alternatively, shears 10 may be inverted from what is shown, in which case it facilitates the cutting of a sheet material at a lower location, for example, on a worktable proximate the operator's waist. Before proceeding further, it is noted that the various directional terms (e.g., upward/downward, forward/rearward, upper/lower, front/rear) appearing herein is for convenience only when referring to the drawings and is not intended to be limiting.

Shears 10 includes upper and lower blade members 12 and 14, which are pivotable about a blade pivot bolt 16 by actuation of front and rear elongated handle members 18 and 20. Handle members 18 and 20 are, in turn, pivotable about a handle pivot bolt 22 located at the upper ends of handle members 18 and 20. The lower portions of front and rear handle members 18 and 20 include respective front and rear hand grips 24 and 26. Preferably, front and rear hand grips 24 and 26 are configured to provide a comfortable and secure grip for the operator's palm and fingers, respectively, which allows for one-hand operation of shears 10. As illustrated, front and rear hand grips 24 and 26 include a finger enclosing loop 28 and a raised shoulder 30, respectively, which prevent the operator's hand from sliding towards blade members 12 and 14 during use. To simplify the manufacture and reduce the costs of shears 10, hand grips 24 and 26 may be integrally formed with handle members 18 and 20. Handle members 18 and 20 may be constructed of any suitable material, including various plastic or metal materials well known to those skilled in the art. Preferably, however, handle member 18 and 20 are made of a lightweight material to facilitate the use of shears 10 for cutting materials above the operator's shoulders. To this end, handle member 18 and 20 may be hollow throughout their entire length to further reduce the weight of shears 10. Grips 24 and 26 are preferably made from a soft cushion-like material to provide the operator with a secure yet comfortable grip. Those skilled in the art will know of several materials that are suitable for making such grips, but one particularly preferred material is a thermoplastic elastomer (TPE) manufactured by KRATON Polymers.

Upper and lower blade members 12 and 14 are pivotably connected to respective front and rear handle members 18 and 20 at respective front and rear handle-blade pivot bolts 32 and 34. In FIGS. 1 and 2, it can be seen that handle pivot bolt 22 is located intermediate the blade (upper) pivot bolt 16 and the two handle-blade (lower) pivot bolts 32 and 34. This linkage arrangement provides shears 10 with a powerful compound cutting action that facilitates the cutting of heavy sheet material. In a particularly preferred embodiment, handle pivot bolt 22 is located approximately centrally of the blade (upper) pivot bolt 22 and the two handle-blade (lower) pivot bolts 32 and 34.

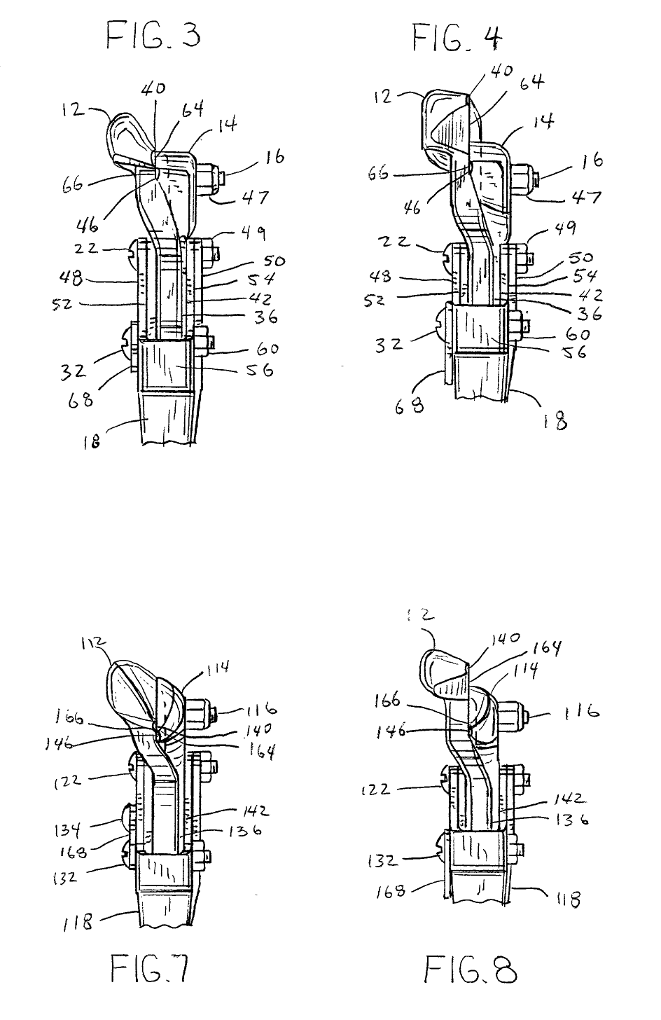

Upper blade member 12 extends upward and rearward from a shank 36 proximate front handle-blade pivot bolt 32 to a mid blade portion 38 proximate blade pivot bolt 16, and then forward to a distal tip 40. Similarly, lower blade member 14 extends upward and forward from a shank 42 proximate rear handle-blade pivot bolt 34 to a mid blade portion 44 proximate blade pivot bolt 16, and then forward to a distal tip 46. Blade pivot bolt 16 forms a sliding fit with a hole formed in mid blade portions 38 and 44 of blade members 12 and 14. As shown in FIGS. 3 and 4, a lock nut 47 may be threaded onto blade pivot bolt 16 to allow easy adjustment of the play and frictional engagement in the blade pivot point. Similarly, a nut 49 may be threaded onto handle pivot bolt 22 to allow easy adjustment of the amount of play and friction in the handle pivot point.

Front and rear handle members 18 and 20 preferably have a U-shaped cross-section formed by laterally spaced side portions 48, 50 and 52, 54, respectively, each pair of which is joined by an associated web portion 56 and 58. Blade shanks 36 and 42 have sufficient thickness so as to be closely received by respective handle side portions 48, 50 and 52, 54, which maintains alignment of blade members 12 and 14 during use of shears 10. Adjustment of the play between the side portions 48, 50 and the blade shank 36, and also between side portions 52, 54 and shank 42, is provided by an adjustment nut 60 threaded onto each handle-blade pivot bolt 32 and 34.

Returning now to FIGS. 1 and 2, upper blade member 12 preferably includes a cutting edge 64 that remains substantially perpendicular to the longitudinal direction of front handle member 18 during actuation of shears 10. Similarly, lower blade member 14 preferably includes a cutting edge 66 that remains approximately perpendicular to the longitudinal direction of rear handle member 20 during actuation of shears 10. Thus, cutting edges 64 and 66 extend substantially perpendicular to a line 67 drawn between handles 18 and 20 when shears 10 is in the closed position (shown in FIG. 1). With 90° configuration between the blades and the handles—that is, between the cutting/operating plane and the actuating plane of shears 10—upper and lower blade members 12 and 14 are capable of operating upon a substantially horizontal sheet of material while handle members 18 and 20 are extending in a generally vertical direction. Thus, the operator's arms do not have to be raised and/or extended as much (or perhaps not at all) when cutting a sheet material located at a raised position, such as above the operator's shoulders. Instead, the operator's arms can be maintained at a lower position closer to the operator's trunk, which may allow the operator to develop more power because of the improved leverage position. This 90° blade/handle configuration is also advantageous in that it allows the cut sheet material to pass by the sides of the relatively narrow blade members 12 and 14 without interfering in any way with the relatively wide handle members 18 and 20 or the actuating plane of shears 10. Thus, the operator's hands are not at risk of being injured by the freshly cut sheet material edges. Those skilled in the art will recognize that some of these advantages can be achieved (at least partially) by having a somewhat different blade/handle configuration, for example, between about 80° to 100° or between about 70° to 110°, rather than 90°.

Another feature of the present invention is a locking strap 68 which can be used to prevent shears 10 from opening from the closed position shown in FIG. 1. As illustrated, the locking strap 68 is pivotably mounted at one of its ends on the shank of front handle-blade pivot bolt 32, where it is captured between the head of bolt 32 and the outer surface of side portion 48 of front handle member 18. A free end 70 of locking strap 68 is notched in a side portion thereof so as to form a hooked surface 72 configured to engage the shank of rear handle-blade pivot bolt 34. Locking strap 68 is manually pivotable between a first position (shown in FIG. 1) which locks shears 10 in the closed position and a second position (shown in FIG. 2) which permits operation of shears 10. Locking strap 68 may conveniently be released or engaged by the operator's thumb to permit one-hand operation.

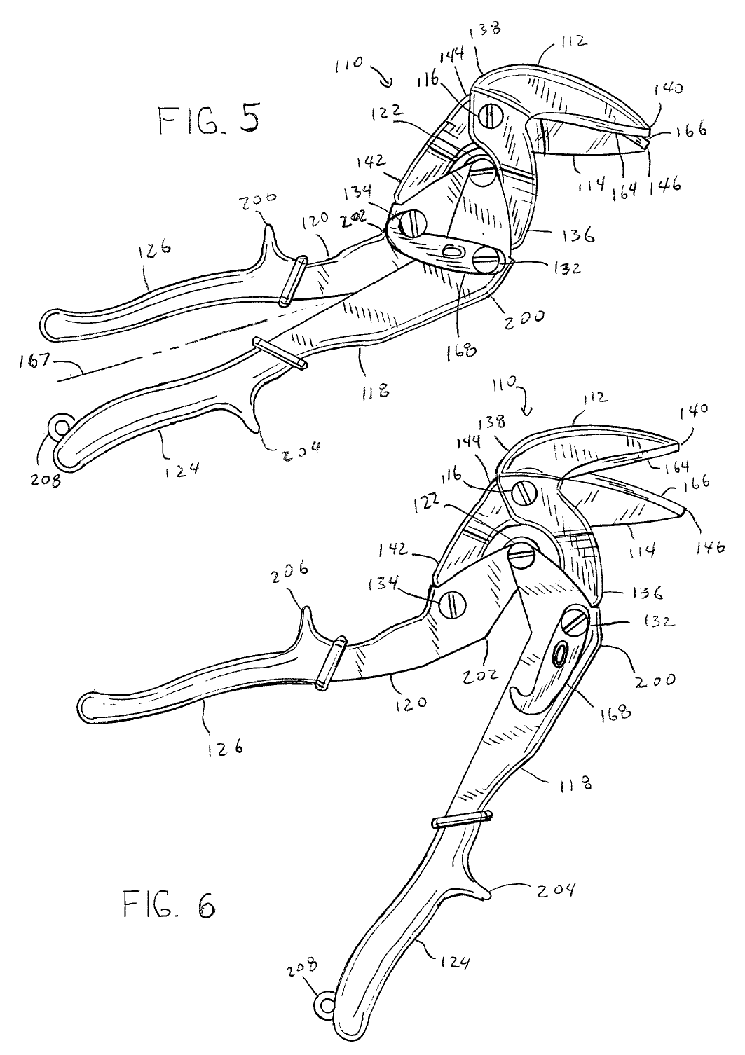

Referring now to FIGS. 5-8, another embodiment of a shears 110 useful for cutting a sheet material located at a raised or lowered position will now be described. For brevity, the written description of shears 110 that follows will generally be limited to aspects thereof which differ from shears 10 described above. The components in shears 110 that are similar in structure and function to like-components in shears 10 will be designated by the same reference numerals but increased by 100. Elements of shears 110 discussed below that do not correspond to like-components in shears 10 will begin with reference numeral 200.

Shears 110 is similar to shears 10 described above in terms of its overall structure and linkage arrangement. For example, shears 110 includes upper and lower blade members 112 and 114, which are pivotable about a blade pivot bolt 116 by actuation of front and rear elongated handle members 118 and 120. Handle members 118 and 120 are pivotable about a handle pivot bolt 122 located intermediate of (and preferably centrally to) the blade (upper) pivot bolt 116 and the front and rear handle-blade (lower) pivot bolts 132 and 134. As explained above, this linkage arrangement provides shears 110 with a powerful compound cutting action that facilitates the cutting of heavy sheet materials and/or the cutting of materials located in a position that places the operator's arms in a weakened power position (e.g., raised above the shoulders and/or outstretched from the operator's body). Handle members 118 and 120 may include hand grips 124 and 126 to provide a comfortable and secure grip for one (or both) of the operator's hands. Shears 110 may also include a locking strap 168 which can be used to prevent shears 110 from opening from the closed position shown in FIG. 5.

As shown in FIGS. 5 and 6, blade members 112 and 114 are substantially similar to respective blade members 12 and 14 of shears 10 as described above. For example, upper blade member 112 extends upward and rearward from a shank 136 proximate front handle-pivot bolt 132 to a mid blade portion 138 proximate blade pivot bolt 116, and then forward to a distal tip 140. Similarly, lower blade member 114 extends upward and forward from a shank 142 proximate rear handle-pivot bolt 134 to a mid blade portion 144 proximate blade pivot bolt 116, and then forward to a distal tip 146.

Shears 110 differs from shears 10 as described above primarily in the construction of handle members 118 and 120. Of most significance, handle members 118 and 120 includes respective bends 200 and 202 which cause the trailing portions thereof (including hand grips 124 and 126) to extend obliquely relative to cutting edges 164 and 166 formed on respective upper and lower blade members 112 and 114. Preferably, handle members 118 and 120 extend at an angle between about 25° to 65° relative to the respective cutting edges 164 and 166, and more preferably between about 35° to 55° relative to respective cutting edges 164 and 166. In a particularly preferred embodiment, handle members 118 and 120 extend at an angle of approximately 45° relative to respective cutting edges 164 and 166. Thus, cutting edges 164 and 166 extend at an angle of approximately 45° relative to a line 167 drawn between handles 118 and 120 when shears 110 is in the closed position (shown in FIG. 5). With this 45° configuration between the blade cutting surfaces and the handles—that is, between the cutting/operating plane and the actuating plane of shears 110—the operator can easily cut relatively heavy sheet material even when the material is positioned above the operator's shoulders (or at or below the operator's waist) due (1) to the advantageous orientation of the handles relative to working plane, (2) the compound cutting action provided by the disclosed linkage arrangement, and (3) the tendency of the cut edges of the sheet material to move past the relatively narrow blades 112 and 114 of shears 110 without interfering with the relatively wide handle members 118 and 120 or the associated actuating plane.

Handle members 118 and 120 of shears 110 also differ from the handles of shears 10 in other ways. For example, hand grips 124 and 126 on respective handle members 118 and 120 include raised projections 204 and 206 instead of a finger loop and a raised shoulder. Nevertheless, projections 204 and 206 serve similar purposes, that is, preventing the operator's hand(s) from inadvertently sliding towards blades 112 and 114 during use. Grips 124 and 126 may be formed of any suitable material, such as a hot-dip plastisol. Handle member 118 may also include a small ring 208 which enables shears 110 to be conveniently hung from an operator's belt-loop when temporarily not in use or on a storage rack for longer term storage.

It is important to note that the construction and arrangement of the elements of the metal cutting shears shown in the preferred and exemplary embodiments described above is illustrative only. Although only certain embodiments of the present inventions have been described in detail, those skilled in the art will appreciate that many modifications are possible (e.g., variations in sizes, dimensions, structures, shapes and proportions of the various elements, mounting arrangements, use of materials, colors, orientations, etc.) without materially departing from the novel teachings and advantages of the subject matter recited in the claims. For example, a biasing means (such as a spring) could be mounted on handle pivot bolt 22 (or 122) to bias shears 10 (or 110) to an open position. Accordingly, all such modifications are intended to be included within the scope of the present invention as defined in the appended claims. Other substitutions, modifications, changes and omissions may be made in the design, operating conditions and arrangement of the preferred and other exemplary embodiments without departing from the spirit of the present inventions as expressed in the appended claims.

What is claimed is:

1. A shears for cutting a sheet material, comprising:
first and second handle members pivotally connected together at a first pivot point adjacent an end of each handle member; and
first and second blade members pivotally connected together at a second pivot point located beyond the pivoted ends of the handle members, the first and second blade members being pivotally connected to the respective first and second handle members at respective third and fourth pivot points located along the length of each handle member,
wherein each blade member includes a cutting edge that extends at an angle relative to a longitudinal direction of the handle member to which the blade member is pivotally connected.

2. The shears of claim 1, wherein the cutting edge of each blade member extends substantially perpendicular to the longitudinal direction of the handle to which the blade member is pivotally connected.

3. The shears of claim 1, wherein the cutting edge of each blade member extends obliquely relative to the longitudinal direction of the handle to which the blade member is pivotally connected.

4. The shears of claim 1, wherein the cutting edge of each blade member extends at an angle between about 25° and about 65° relative to the longitudinal direction of the handle to which the blade member is pivotally connected.

5. The shears of claim 1, wherein the cutting edge of each blade member extends at an angle between about 35° and about 55° relative to the longitudinal direction of the handle to which the blade member is pivotally connected.

6. The shears of claim 1, wherein the cutting edge of each blade member extends at an angle of about 45° relative to the longitudinal direction of the handle to which the blade member is pivotally connected.

7. The shears of claim 1, wherein the first pivot point is located intermediate the second pivot point and the third and fourth pivot points.

8. The shears of claim 7, wherein the first pivot point is located approximately centrally of the second pivot point and the third and fourth pivot points.

9. The shears of claim 1, wherein each handle member includes a soft cushion-like hand-grip opposite the pivoted end.

10. The shears of claim 1, wherein the shears is configured for one-hand operation, including a palm grip on one of the handle members and a finger grip on the other of the handle members.

11. The shears of claim 10, wherein at least one of the pivot points comprises a threaded bolt and a lock nut for adjusting an amount of play or friction in the pivot point.

12. A shears for cutting a sheet material, comprising:
first and second handle members pivotally connected together at a first pivot point; and
first and second blade members pivotally connected together at a second pivot point, the first and second blade members being pivotally connected to the first and second handle members at respective third and fourth pivot points,
wherein each blade member includes a cutting edge that extends substantially perpendicular relative to a longitudinal direction of the handle member to which the blade member is pivotally connected.

13. The shears of claim 12, wherein the first pivot point is located at an upper end of each of the handle members.

14. The shears of claim 13, wherein the second pivot point is located above the pivoted upper ends of the handle members.

15. The shears of claim 13, wherein the third and fourth pivot points are located below the pivoted upper ends of the handle members.

16. The shears of claim 12, wherein the first pivot point is located approximately centrally of the second pivot point and the third and fourth pivot points.

17. The shears of claim 12, further including a locking strap for selectively maintaining the shears in a closed position.

18. The shears of claim 12, wherein at least one of the pivot points comprises a threaded bolt and a lock nut for adjusting an amount of play or friction in the pivot point.

19. A shears for cutting a sheet material located above the shoulders of an operator, comprising:
front and rear handle members pivotally connected together at a first pivot point adjacent an upper end of each handle member; and
upper and lower blade members pivotally connected together at a second pivot point located above the upper ends of the handle members, the upper and lower blade members being pivotally connected to the front and rear handle members at respective third and fourth pivot points located along the length of each handle member,
wherein each blade member includes a cutting edge that extends obliquely relative to a longitudinal direction of the handle member to which the blade member is pivotally connected.

20. The shears of claim 19, wherein each handle member includes a soft cushion-like hand-grip at a lower end thereof.

21. The shears of claim 20, wherein the hand-grip is made from a thermoplastic elastomer.

22. A shears for cutting a sheet material located above the shoulders of an operator, comprising:
front and rear handle members pivotally connected together at a first pivot point adjacent an upper end of each handle member; and
upper and lower blade members pivotally connected together at a second pivot point located above the upper ends of the handle members, the upper and lower blade members being pivotally connected to the front and rear handle members at respective third and fourth pivot points located along the length of each handle member,
wherein each blade member includes a cutting edge that extends substantially perpendicular relative to a longitudinal direction of the handle member to which the blade member is pivotally connected.

23. The shears of claim 22, wherein each handle member includes a soft cushion-like hand-grip at a lower end thereof.

24. The shears of claim 23, wherein the hand-grip is made from a thermoplastic elastomer.

25. A shears for cutting a sheet material comprising:
a pair of elongated handles pivotally connected adjacent one of the ends thereof; and
a pair of blades pivotable between an open position and a closed position by actuation of the handles,
wherein the blades include cooperating cutting edges, the cutting edges extending substantially perpendicular to a line extending between the handles when the blades are in the closed position.

26. The shears of claim 25, wherein each handle includes a soft cushion-like grip opposite the pivoted end.

27. The shears of claim 26, wherein the hand-grip is made from a thermoplastic elastomer.
